(19) United States
(12) Patent Application Publication
(10) Pub. No.: US 2025/0150781 A1
(43) Pub. Date: May 8, 2025

(54) CONTROLLING ACCESS POINT LOCATION CROWDSOURCING

(71) Applicant: Cisco Technology, Inc., San Jose, CA (US)

(72) Inventors: Al Dumdei, San Jose, CA (US); Carlos E. Alcantara, San Jose, CA (US); Brian D. Hart, Sunnyvale, CA (US); Sarath Gorthi Subrahmanya, San Jose, CA (US); Jerome Henry, Pittsboro, NC (US)

(73) Assignee: Cisco Technology, Inc., San Jose, CA (US)

(21) Appl. No.: 18/937,778

(22) Filed: Nov. 5, 2024

Related U.S. Application Data
(60) Provisional application No. 63/596,295, filed on Nov. 5, 2023.

(51) Int. Cl. H04W 4/021; H04L 41/0803

(52) U.S. Cl. CPC H04W 4/021; H04L 41/0803

(57) ABSTRACT

Control of service provider information collection and, particularly, control of Access Point (AP) location crowdsourcing and time zone information may be provided. A time zone to use in a venue can be determined. A time zone field can be set indicating the time zone. A venue mobility field can be set indicating the venue is mobile. One or more elements comprising the time zone field and the venue mobility field can be sent to a Station (STA), wherein the STA is operable to use the time zone according to the time zone field and based on the venue mobility field indicating the venue is mobile.

### RELATED APPLICATION

Under provisions of 35 U.S.C. § 119(e), Applicant claims the benefit of and priority to U.S. Provisional Application No. 63/596,295, filed Nov. 5, 2023, the disclosure of which is incorporated herein by reference in its entirety.

### TECHNICAL FIELD

The present disclosure relates generally to providing control of service provider information collection and particularly to control of Access Point (AP) location crowdsourcing and time zone information.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for control of Access Point (AP) location crowdsourcing in accordance with aspects of the present disclosure.

FIG. 2 is a block diagram of a time zone element in accordance with aspects of the present disclosure.

FIG. 3 is a block diagram of a mobility and privacy element in accordance with aspects of the present disclosure.

FIG. 4 is a block diagram of a map with a venue traveling between time zones in accordance with aspects of the present disclosure.

FIG. 5 is a flow chart of a method for control of AP location crowdsourcing and time zone information in accordance with aspects of the present disclosure.

FIG. 6 is a block diagram of a computing device in accordance with aspects of the present disclosure.

FIG. 7 is a block diagram of a computing device in accordance with aspects of the present disclosure.

### DETAILED DESCRIPTION

### Overview

Control of service provider information collection and, particularly, control of Access Point (AP) location crowdsourcing and time zone information may be provided. A time zone to use in a venue can be determined. A time zone field can be set indicating the time zone. A venue mobility field can be set indicating the venue is mobile. One or more elements comprising the time zone field and the venue mobility field can be sent to a Station (STA), wherein the STA is operable to use the time zone according to the time zone field and based on the venue mobility field indicating the venue is mobile.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Service providers can collect Wi-Fi local network information, such as Basic Service Set Identifier (BSSID) information, and use the collected information to provide information to clients. For example, the service providers can collect the BSSID information from network devices such as Access Points (APs), crowd sourced information collected from clients, and the like. The service providers can use the collected BSSID information to send client location information, client time zone information, and provide other services.

However, multiple issues can arise due to the collection of BSSID information, including crowd sourced information from clients. For instance, network owners may not want to be tracked, such as home networks, corporate networks, and the like. The current methods for requesting service providers not to perform tracking services using BSSID information is not preferred. A no-tracking request can be expressed by tagging the Service Set Identifier (SSID) in a way specified by the service provider. However, this method puts the burden on the network devices, including APs, to implement a Station (STA)-specific SSID scheme (e.g., the network is forced to change the SSID value, and include a string that the service provider will identify the network as private with a no-tracking request or public). Further, the method may be service provider specific and does not scale.

The service provider also does not have any information about the venue. For example, the service provider may not know whether the network is private (e.g., a home, a small office), whether the network is stable or transient (e.g., SSID transient onboard a bus, a boat along a river, any other moving vehicle). As a result, the time zone information and other location information provided may be incorrect (e.g., a series of BSSIDs detected in a Paris train station may also appear in a London train station). Thus, local network devices (e.g., APs) may want clients in a venue to use information the local network devices provide rather than potentially conflicting information from other sources.

This one-sided collection of information with a requirement to set SSIDs to request service providers not to collect traffic information can be inefficient, violate Personally Identifiable Information (PII) requirements of various jurisdictions, lead to inaccurate information, and the like. Thus, methods and systems for controlling the collection of crowdsourced information and for sharing information with clients described herein address these issues. For example, the methods and systems can ensure that the correct or otherwise preferred time zone information is correctly shared.

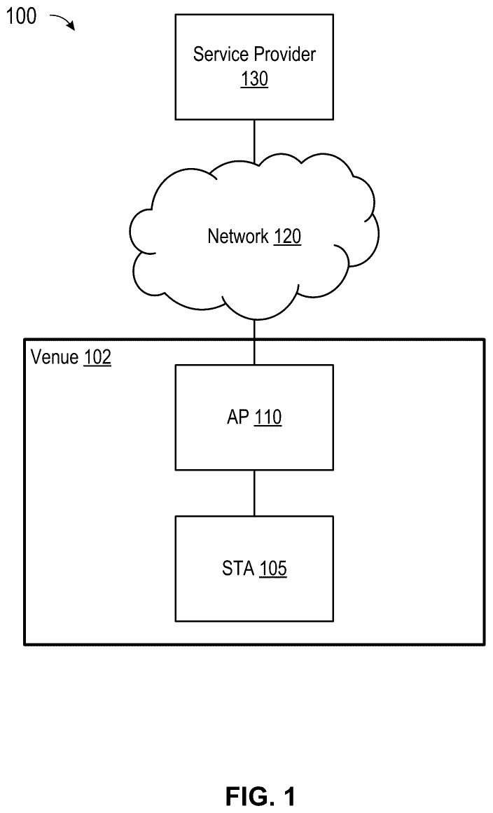

FIG. 1 is a block diagram of an operating environment 100 for control of AP location crowdsourcing. The operating environment 100 includes a venue 102 with a STA 105 and an AP 110. The venue 102 may be any area, structure, or the like. The AP 110 may enable devices to access a network 120, such as by creating a local network (e.g., a Wireless Local Area Network (WLAN)). The local network may be identified by a SSID, and the AP 110 may be identified by a BSSID. Thus, the local network may be identified by the SSID and any BSSIDs of associated APs, including the AP 110. The AP 110 may provide coverage throughout the venue 102. The STA 105 can be any device that connects to the wireless network via the APs 104, such as a smart phone, a tablet, a personal computer, a server, an Internet-of-Things device, and the like. The venue 102 may include any number of STAs 105 and APs 110 in embodiments, and the STAs 105 and APs 110 can perform the operations described herein.

The operating environment 100 also includes the network 120 and a service provider 130. The network 120 can be a network of devices that can share information and communicate with the other devices connected to the network 120. The service provider 130 can be an entity and devices associated with an entity that provide clients services, such as connection to the network 120, services provided via the network 120, and the like. There may be more networks and/or service providers 130 operable to perform the operations described herein.

The AP 110 can advertise a time standard and time zone for clients, such as the STA 105, so the clients can determine the time and time zone to use. The AP 110 can advertise the time zone in a probe response, a beacon, and/or other types of frames sent to the STA 105. In certain situations, the AP 110 and associated local network (e.g., as identified by a BSSID and/or SSID) may want the STA 105 to use the advertised time zone information and/or other information rather than using potentially conflicting information that can be received from other sources via the network 120, such as from the service provider. For example, the venue 102 may be mobile and potentially moving through time zones, but the AP 110 may want to establish a set time zone to synchronize the clocks of devices in the venue 102, including the STA 105. Thus, the AP 110 will want the STA 105 to use the time zone information the AP 110 provides rather than time zone information from other sources. The AP 110 can also indicate to the service provider 130 to not collect local network information (e.g., BSSID information) for location services and the like provided by the service provider 130. For example, when the Coordinated Universal Time (UTC) Timing Synchronization Function (TSF) offset value (i.e., dot11UTCTSOffsetActivated) is set to true, the AP 110 can add fields to exiting elements (e.g., a time zone element) or include a new element to indicate whether the venue 102 is stationary or mobile, indicate whether the service provider 130 can collect information, and/or the like, as will be described in detail herein.

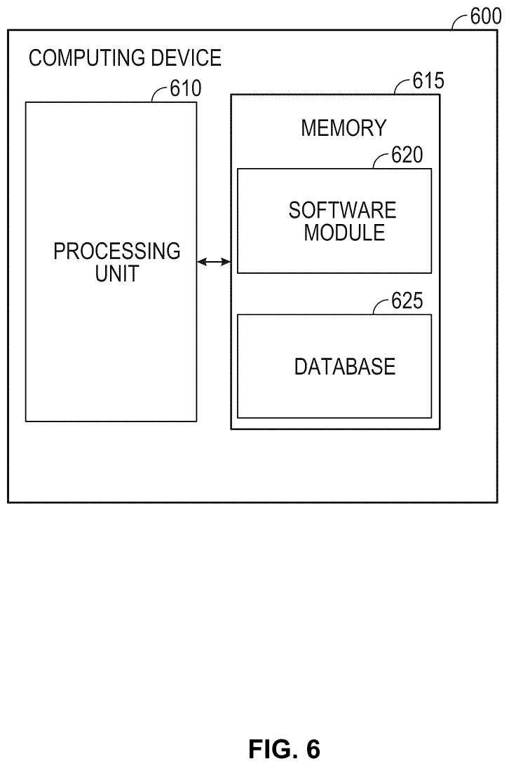

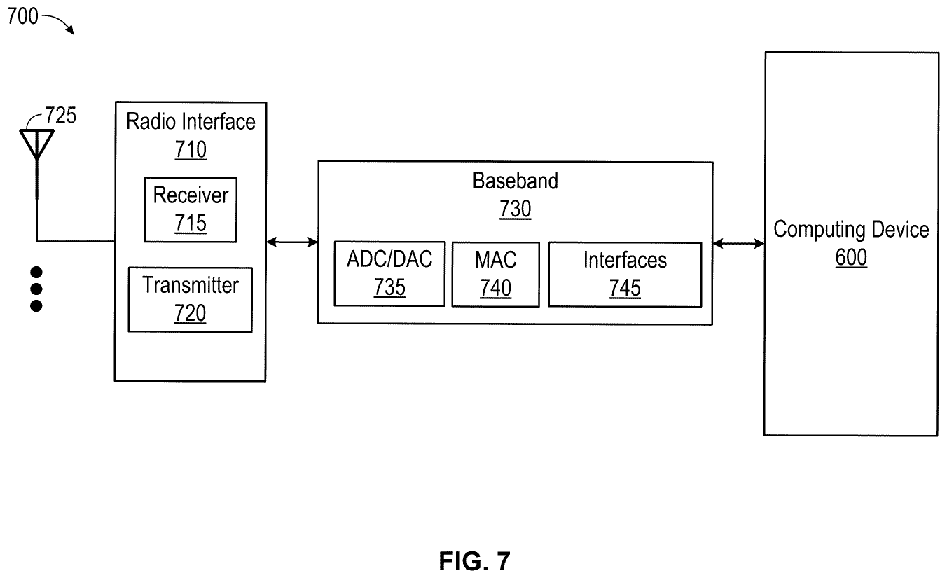

The elements described above of the operating environment 100 (e.g., the STA 105, the AP 110, the service provider 130, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 6 and 7, the elements of the operating environment 100 may be practiced in a computing device 600 and/or communications device 700.

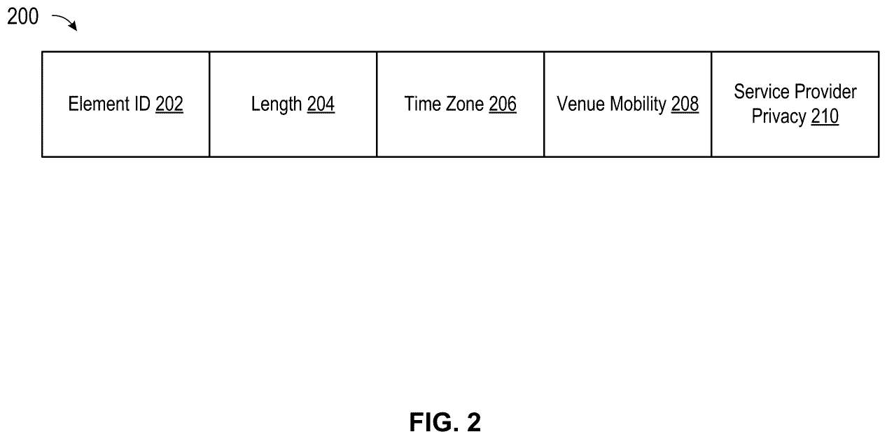

FIG. 2 is a block diagram of a time zone element 200. The AP 110 can utilize the time zone element 200 to share time zone information with clients, such as the STA 105, to indicate to clients to use the time zone indicated in the time zone element 200 rather than information from other sources, such as the service provider 130, and indicate to the service provider 130 whether it can collect information. The time zone element 200 may be utilized as described by the Institute of Electrical and Electronics Engineers (IEEE) 802.11 standards and amendments. For example, when the UTC TSF offset value is set to true, the time zone element 200 may be included in probe responses and beacon frames the AP 110 sends, for example to the STA 105. When the UTC TSF offset value is set to false, the time zone element 200 may not be included in beacons, probe responses, and other frames the AP 110 sends.

In some embodiments, when the UTC TSF offset value is set to true, a time advertisement element is also present in the frames the AP 110 includes the time zone element 200 in. The time advertisement element can be used to indicate a time offset between the time standard and the TSF timer and other time information, but the AP 110 may determine to only send time zone information. Thus, the AP 110 can set the time advertisement element to a null value so clients (e.g., the STA 105) can ignore or otherwise disregard the time advertisement element when it is present in a frame. In other embodiments, the AP 110 can omit the time advertisement element when the UTC TSF offset value is set to true. For example, a new Management and Information Base (MIB) variable, referred to as a venue mobility and privacy MIB variable herein, can be implemented to modify the behavior flowing from the UTC TSF offset value being set to true, such as to omit the time advertisement element, add fields to the time zone element 200 or include a new element to indicate whether the venue 102 is stationary or mobile and whether the service provider 130 can collect information, and/or the like.

When the venue mobility and privacy MIB variable is true, the time zone element 200 can include an element identifier field 202, a length field 204, a time zone field 206, a venue mobility field 208, and a service provider privacy field 210. The element identifier field 202 identifies the type of element, in this case identifying the time zone element 200 as the element for indicating time zone information. The length field 204 indicates the number of octets in the time zone element 200 excluding the length of the element identifier field 202 and the length field 204. The time zone field 206 includes time zone information for recipient devices, such as the STA 105, to use the intended time zone. For example, the time zone field 206 can be a string indicating the time zone the AP 110 wants devices located in the venue 102 to use.

The venue mobility field 208 indicates whether the venue associated with the sending device (e.g., the venue 102 when the AP 110 is sending the time zone element 200) is mobile or not mobile. For example, the venue mobility field 208 may be a single bit that indicates the venue 102 is mobile when the bit is set to one and the venue 102 is not mobile when the bit is set to zero. When the venue mobility field 208 indicates that the venue 102 is mobile, clients may determine or otherwise be aware to use the time zone according to the information in the time zone field 206 rather than information from other sources such as the service provider 130. Thus, the venue 102 and its associated devices, including the AP 110, can set a time zone for the venue 102 that may deviate from the actual time zone (e.g., as indicated by the STA's Global Navigation Satellite System information) or the time zone set by other devices. Setting the time zone can be useful for the venue 102 when the venue 102 wants to maintain a time zone to avoid confusion between clients, such as when the venue 102 is a cruise ship, a train, an airplane, etc. When the venue mobility field 208 indicates that the venue 102 is stationary, the clients (e.g., the STA 105) may determine the time zone via any available information.

In response to determining the venue 102 is mobile via the venue mobility field 208, the STA 105 may apply other metrics to determine whether to use the time zone indicated in the time zone field 206. For example, the STA 105 may determine whether the time zone element 200 was sent from a trusted AP, whether the STA 105 was recently at a location using the indicated time zone (e.g., the STA 105 was at port with the indicated time zone within a few hours of receiving the time zone field 206, the GNSS-determined time zone is the same or within a few hours of the indicated time zone), and/or the like before accepting the time zone indicated in the time zone field 206. Once the STA 105 accepts the time zone indicated in the time zone field 206, that time zone would then override the value determined by the STA 105 from other sources.

The service provider privacy field 210 can indicate whether service providers can collect the information. For example, the service provider privacy field 210 may be a single bit that indicates that service providers cannot collect information or the associated venue is otherwise private when the bit is set to one. When the bit is set to one, the service provider privacy field 210 can indicate that the service providers can collect information or the associated venue is otherwise public. Thus, the AP 110 can set the service provider privacy field 210 to one to prevent the service provider 130 from collecting local network information (e.g., the time zone indicated in the time zone field 206) or can set the service provider privacy field 210 to zero to allow the service provider 130 to collect local network information. The AP 110 can also use the service provider privacy field 210 to indicate crowdsourcing devices to not collect local network information, such as instructing service providers, device vendors, network devices, etc. to collect information, for example for incorporation into location services. In response to the service provider privacy field 210 being set to indicate not to collect information, crowd sourcing entities and device, such the service provider 130, may change their current collection parameters to avoid collecting the information.

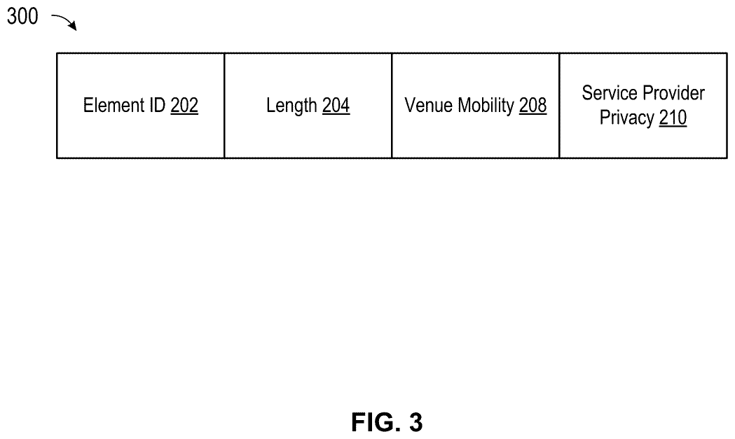

The venue mobility field 208 and the service provider privacy field 210 may be included in other elements in additional embodiments. The venue mobility field 208 and the service provider privacy field 210. For example, FIG. 3 is a block diagram of a mobility and privacy element 300. The mobility and privacy element 300 may be a new element to send the venue mobility field 208 and service provider privacy field 210 to clients (e.g., the STA 105). The mobility and privacy element 300 can include the element identifier field 202, the length field 204, the venue mobility field 208 and service provider privacy field 210. The element identifier field 202 can identify the mobility and privacy element 300, and the length field 204 can indicate the length of the mobility and privacy element 300 minus the element identifier field 202 and the length field 204.

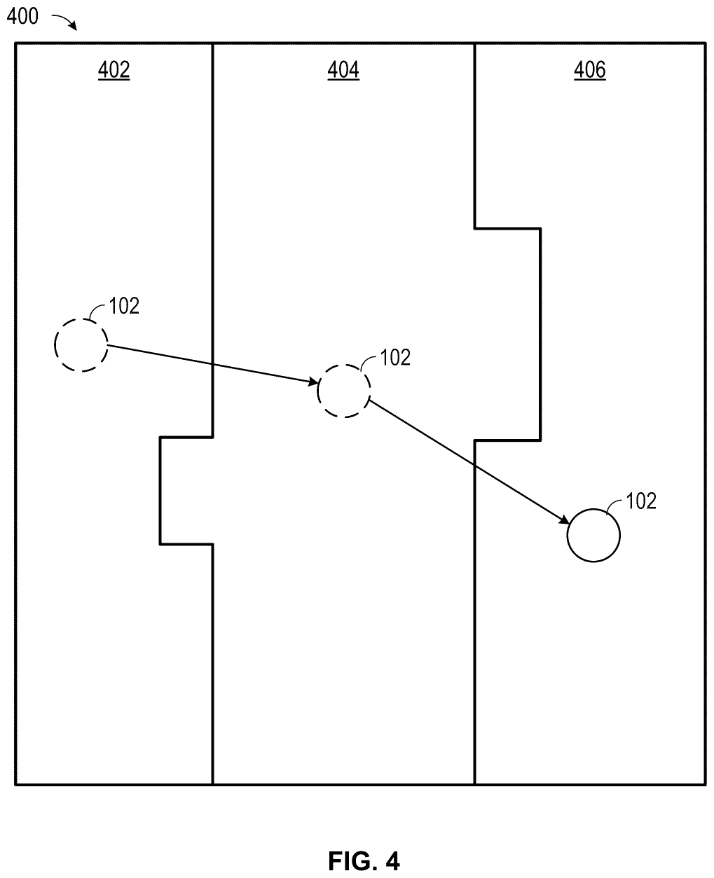

FIG. 4 is a block diagram of a map 400 with the venue 102 traveling between time zones. The map 400 includes a first time zone 402, a second time zone 404, and a third time zone 406. The venue 102 may be mobile, so the AP 110 may send a time zone element 200 to the STA 105 with the venue mobility field 208 indicating that the venue 102 is mobile. The STA 105 may determine to use the time of the first time zone 402 for devices in the venue 102. Thus, the STA 105 will indicate the time of the first time zone 402 in the time zone field 206. The STA 105 can identify that the venue 102 is mobile based on the venue mobility field 208 and therefore use the time of the first time zone 402 even while the venue 102 travels to a location in the second time zone 404 and subsequently to a location in the third time zone 406. The AP 110 can update the time zone field 206 in subsequent communications with the STA 105 as desired. Thus, the AP 110 can update the time zone devices in the venue 102 use as desired.

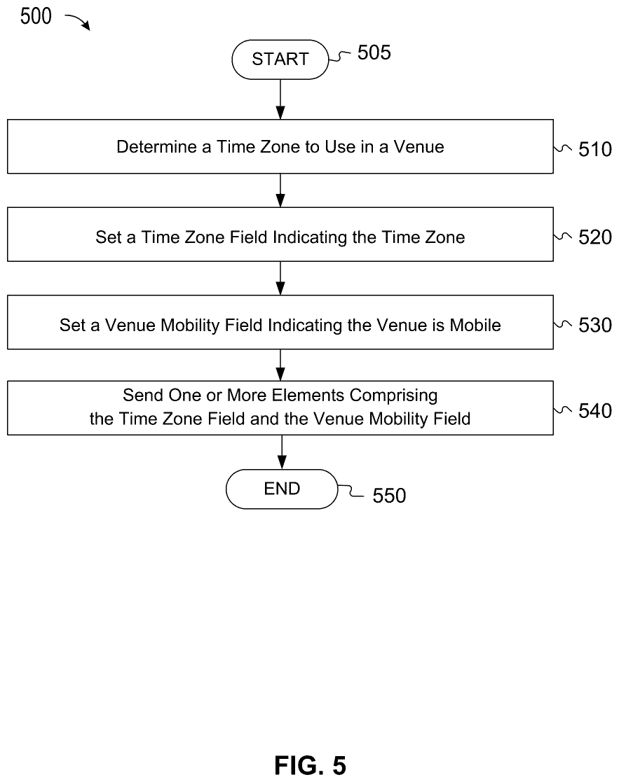

FIG. 5 is a flow chart of a method 500 for control of AP location crowdsourcing and time zone information. The method 500 may begin at starting block 505 and proceed to operation 510. In operation 510, a time zone to use in a venue is determined. For example, the AP 110 determines a time zone to use for the venue 102. In operation 520, a time zone field is set indicating the time zone. For example, the AP 110 sets the time zone field 206 of a time zone element 200 to indicate the time zone determined in operation 510. In operation 530, a venue mobility field is set indicating the venue is mobile. For example, the AP 110 sets the venue mobility field 208 to indicate the venue 102 is mobile. In operation 540, one or more elements comprising the time zone field and the venue mobility field are sent to a STA. For example, the AP 110 sends the time zone element 200 or a time zone element without the venue mobility field 208 and the mobility and privacy element 300 to the STA 105. The STA 105 can determine to use the time zone indicated in the time zone field 206 even when the venue 102 moves to other time zones.

The method 500 can further comprise the AP 110 setting a service provider privacy field 210 to indicate service providers cannot collect information, wherein the one or more elements further comprise the service provider privacy field 210. In some embodiments, the one or more elements comprise a time zone element 200, the time zone element 200 comprising the time zone field 206, the venue mobility field 208, and the service provider privacy field 210. In other embodiments, the one or more elements comprise (i) a time zone element, the time zone element comprising the time zone field without the venue mobility field 208 and the service provider privacy field 210, and (ii) a mobility and privacy element 300, the mobility and privacy element 300 comprising the venue mobility field 208 and the service provider privacy field 210.

The service provider privacy field 210 may be a single bit, wherein setting the service provider privacy field 210 to a first value indicates service providers cannot collect information; and setting the service provider privacy field 210 to a second value indicates service providers can collect information. The venue mobility field 208 may be a single bit, wherein setting the venue mobility field to a first value indicates the venue is mobile, and setting the venue mobility field to a second value indicates the venue is not mobile. The method 500 may further comprise setting a time advertisement element in the one or more elements to a null value. The method 500 may conclude at ending block 550.

FIG. 6 is a block diagram of a computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for providing control of service provider information collection and, particularly, control of AP location crowdsourcing and time zone information with respect to FIGS. 1-5. Computing device 600, for example, may provide an operating environment for STA 105, the AP 110, the service provider 130, and the like. The STA 105, the AP 110, the service provider 130, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 600 on the single integrated circuit (chip).

FIG. 7 illustrates an implementation of a communications device 700 that may implement one or more of the STA 105, the AP 110, the service provider 130, etc., of FIGS. 1-5. In various implementations, the communications device 700 may comprise a logic circuit. The logic circuit may include physical circuits to perform operations described for one or more of the STA 105, the AP 110, the service provider 130, etc., of FIGS. 1-5, for example. As shown in FIG. 7, the communications device 700 may include one or more of, but is not limited to, a radio interface 710, baseband circuitry 730, and/or the computing device 600.

The communications device 700 may implement some or all of the structures and/or operations for the STA 105, the AP 110, the service provider 130, etc., of FIGS. 1-5, storage medium, and logic circuit in a single computing entity, such as entirely within a single device. Alternatively, the communications device 700 may distribute portions of the structure and/or operations using a distributed system architecture, such as a client station server architecture, a peer-to-peer architecture, a master-slave architecture, etc.

A radio interface 710, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 710 may include, for example, a receiver 715 and/or a transmitter 720. The radio interface 710 may include bias controls, a crystal oscillator, and/or one or more antennas 725. In additional or alternative configurations, the radio interface 710 may use oscillators and/or one or more filters, as desired.

The baseband circuitry 730 may communicate with the radio interface 710 to process, receive, and/or transmit signals and may include, for example, an Analog-To-Digital Converter (ADC) for down converting received signals with a Digital-To-Analog Converter (DAC) 735 for up converting signals for transmission. Further, the baseband circuitry 730 may include a baseband or PHYsical layer (PHY) processing circuit for the PHY link layer processing of respective receive/transmit signals. Baseband circuitry 730 may include, for example, a Media Access Control (MAC) processing circuit 740 for MAC/data link layer processing. Baseband circuitry 730 may include a memory controller for communicating with MAC processing circuit 740 and/or a computing device 600, for example, via one or more interfaces 745.

In some configurations, PHY processing circuit may include a frame construction and/or detection module, in combination with additional circuitry such as a buffer memory, to construct and/or deconstruct communication frames. Alternatively or in addition, MAC processing circuit 740 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
determining a time zone to use in a venue;
setting a time zone field indicating the time zone;
setting a venue mobility field indicating the venue is mobile; and
sending one or more elements comprising the time zone field and the venue mobility field to a Station (STA), wherein the STA is operable to use the time zone according to the time zone field and based on the venue mobility field indicating the venue is mobile.

2. The method of claim 1, further comprising setting a service provider privacy field to indicate service providers cannot collect information, wherein the one or more elements further comprise the service provider privacy field.

3. The method of claim 2, wherein the one or more elements comprise a time zone element, the time zone element comprising the time zone field, the venue mobility field, and the service provider privacy field.

4. The method of claim 2, wherein the one or more elements comprise:
a time zone element, the time zone element comprising the time zone field; and
a mobility and privacy element, the mobility and privacy element comprising the venue mobility field and the service provider privacy field.

5. The method of claim 2, wherein:
the service provider privacy field is a single bit;
setting the service provider privacy field to a first value indicates service providers cannot collect information; and
setting the service provider privacy field to a second value indicates service providers can collect information.

6. The method of claim 1, wherein:
the venue mobility field is a single bit;
setting the venue mobility field to a first value indicates the venue is mobile; and
setting the venue mobility field to a second value indicates the venue is not mobile.

7. The method of claim 1, further comprising setting a time advertisement element in the one or more elements to a null value.

8. A system comprising:
a memory storage; and
a processing unit coupled to the memory storage, wherein the processing unit is operative to:
determine a time zone to use in a venue;
set a time zone field indicating the time zone;
set a venue mobility field indicating the venue is mobile; and
send one or more elements comprising the time zone field and the venue mobility field to a Station (STA), wherein the STA is operable to use the time zone according to the time zone field and based on the venue mobility field indicating the venue is mobile.

9. The system of claim 8, the processing unit being further operative to set a service provider privacy field to indicate service providers cannot collect information, wherein the one or more elements further comprise the service provider privacy field.

10. The system of claim 9, wherein the one or more elements comprise a time zone element, the time zone element comprising the time zone field, the venue mobility field, and the service provider privacy field.

11. The system of claim 9, wherein the one or more elements comprise:
a time zone element, the time zone element comprising the time zone field; and
a mobility and privacy element, the mobility and privacy element comprising the venue mobility field and the service provider privacy field.

12. The system of claim 9, wherein:
the service provider privacy field is a single bit;
to set the service provider privacy field to a first value indicates service providers cannot collect information; and
to set the service provider privacy field to a second value indicates service providers can collect information.

13. The system of claim 8, wherein:
the venue mobility field is a single bit;
to set the venue mobility field to a first value indicates the venue is mobile; and
to set the venue mobility field to a second value indicates the venue is not mobile.

14. The system of claim 8, the processing unit being further operative to set a time advertisement element in the one or more elements to a null value.

15. A non-transitory computer-readable medium that stores a set of instructions which when executed perform a method executed by the set of instructions comprising:
determining a time zone to use in a venue;
setting a time zone field indicating the time zone;
setting a venue mobility field indicating the venue is mobile; and
sending one or more elements comprising the time zone field and the venue mobility field to a Station (STA), wherein the STA is operable to use the time zone according to the time zone field and based on the venue mobility field indicating the venue is mobile.

16. The non-transitory computer-readable medium of claim 15, the method executed by the set of instructions further comprising setting a service provider privacy field to indicate service providers cannot collect information, wherein the one or more elements further comprise the service provider privacy field.

17. The non-transitory computer-readable medium of claim 16, wherein the one or more elements comprise a time zone element, the time zone element comprising the time zone field, the venue mobility field, and the service provider privacy field.

18. The non-transitory computer-readable medium of claim 16, wherein the one or more elements comprise:
a time zone element, the time zone element comprising the time zone field; and
a mobility and privacy element, the mobility and privacy element comprising the venue mobility field and the service provider privacy field.

19. The non-transitory computer-readable medium of claim 16, wherein:
the service provider privacy field is a single bit;
setting the service provider privacy field to a first value indicates service providers cannot collect information; and
setting the service provider privacy field to a second value indicates service providers can collect information.

20. The non-transitory computer-readable medium of claim 15, wherein:
the venue mobility field is a single bit;
setting the venue mobility field to a first value indicates the venue is mobile; and
setting the venue mobility field to a second value indicates the venue is not mobile.
